(19) United States
(12) Patent Application Publication
(10) Pub. No.: US 2002/0039846 A1
(43) Pub. Date: Apr. 4, 2002

(54) Aircraft ground power connector

(76) Inventors: Luis J. Lazaro JR., Shoreline, WA (US); David P. Carter, Laguna Niguel, CA (US)

Correspondence Address: Ann K. Galbraith, 7755 E. Marginal Way South, P.O. Box 3707, MC 13-08, Seattle, WA, 98124-2207, US

(21) Appl. No.: 09/955,834

(22) Filed: Sep. 18, 2001

Related U.S. Application Data
(63) Continuation-in-part of application No. PCT/US00/07181, filed on Mar. 17, 2000.
(60) Provisional application No. 60/125,007, filed on Mar. 18, 1999.

(51) Int. Cl. H01R 33/00

(52) U.S. Cl. 439/34

(57) ABSTRACT

An aircraft ground power connector comprising: (a) a plurality of electrical contact pins embedded in an insulating housing having first and second layers of insulating material, wherein each pin has a male end and female end and is arranged in the housing so that the male ends are protruding from a male side of the connector, and the female ends of the pins (i) are recessed in a female side of the connector, (ii) have a shape, length, and diameter adapted to permit them to receive a male pin, (iii) have slots in the sides thereof; and the housing is a multi-layer assembly having at least two layers of insulating material arranged perpendicular to the direction of the pins; including (i) a first layer of insulating material positioned on the female side of the connector, wherein the first layer and the portion of the female end of the pins embedded therein are shaped to prevent the pin from being pushed out of the female side of the connector; and (ii) a second layer of insulating material positioned so that at least a portion of the slotted female ends are embedded therein, and the second layer is shaped so that the it applies pressure to the outer periphery of the female end sufficient to reduce the size of its inner periphery; and (b) a releasable fastener that holds the first and second layers of the insulating material together.

### CROSS-REFERENCE TO RELATED APPLICATIONS

This application is a continuation-in-part of PCT application Serial No. PCT/US001/07181, filed Mar. 17, 2000, which claims the benefit of U.S. provisional application Serial No. 60/125,007, filed Mar. 18, 1999, both of which are hereby incorporated by reference in their entirety.

### BACKGROUND OF THE INVENTION

This invention relates to aircraft connectors for ground electrical supplies. More particularly, this invention relates to an aircraft fixed connector (receptacle) and ground supply free connector (plug) used on commercial aircraft.

When a commercial aircraft is docked at an airport and its on-board power generator is shut off, the aircraft is connected to the airport power supply system. Typically, a power cart on the ground connected to the airport power supply system has a first connector that is coupled to a second connector on the aircraft located at the bottom of the exterior forward nose cargo area. The coupling between the connectors is typically maintained through the physical engagement between the electrical contact pins on the first connector and the sockets on the second connector. However, the weight of the second connector pulling down on the electrical interface between the pin and socket causes arcing when the power is on. This condition, in addition to the frequency of coupling and uncoupling on these connectors results in eventual breakdown and need for replacement or repair of one or both of the connectors. In addition, replacement of the first connector may take several hours, during which time the aircraft is out of service.

### BRIEF SUMMARY OF THE INVENTION

In one aspect, this invention is an aircraft ground power connector comprising:

(a) a plurality of electrical contact pins embedded in an insulating housing having first and second layers of insulating material, wherein each pin has a male end and female end and is arranged in the housing so that the male ends are protruding from a male side of the connector, and the female ends of the pins (i) are recessed in a female side of the connector, (ii) have a shape, length, and diameter adapted to permit them to receive a male pin, (iii) have slots in the sides thereof; and

the housing is a multi-layer assembly having at least two layers of insulating material arranged perpendicular to the direction of the pins; including (i) a first layer of insulating material positioned on the female side of the connector, wherein the first layer and the portion of the female end of the pins embedded therein are shaped to prevent the pin from being pushed out of the female side of the connector; and (ii) a second layer of insulating material positioned so that at least a portion of the slotted female ends are embedded therein, and the second layer is shaped so that it applies pressure to the outer periphery of the female end sufficient to reduce the size of its inner periphery; and

(b) a releasable fastener that holds the first and second layers of the insulating material together.

It has been discovered that the connector of the invention is particularly useful in aircraft applications as a connector between a ground power supply plug and a fixed connector located on the outside of the aircraft. This connector bears the impact of wear caused by the weight of the relatively heavy power cord attached to the ground power supply, as well as the wear caused by repeated connecting and disconnecting, that would otherwise be borne by the aircraft fixed connector. The connector of the invention may be replaced faster and more economically than a worn aircraft fixed connector. These and other advantages of the invention will be apparent from the description that follows.

### BRIEF DESCRIPTION OF THE SEVERAL VIEWS OF THE DRAWING

FIG. 1 is a cross-sectional view of a connector having male-female electrical contact pins embedded in an insulating housing.

FIG. 2 is a top view of the male side of a connector having four power contact pins and two relay contact pins.

FIG. 3 is a profile view of and an end view of a relay contact pin having a male and female end.

FIG. 4 is a profile view and an end view of a power contact pin having a male and female end.

### DETAILED DESCRIPTION OF THE INVENTION

The electrical contact pins are preferably cylindrically configured and have a proximal male end ofc a solid diameter ending with a spherical nose. The distal female end of the pin is preferably tubular shaped and slotted, with the slots forming at least three cantilever beams, more preferably six cantilever beams. By collapsing the beams evenly towards the radial center of the bore of tubes, these beams, in effect, become individual springs offering a sphincter tension about a male cylinder with a spherical nose as a male cylinder penetrates the tube. At the extreme distal end of the slotted tubes and on the outer periphery of the slotted tubes are preferably configured raised angular crests. At the approximate center between the proximal cylinder and the distal tube is preferably a raised cylindrical collar. This cylindrical collar acts as a retention member which prohibits the removal of the electrical contacts in any axial or radial direction when it is assembled within the dielectric members of the connector of the invention. These electrical contacts are usually constructed from a copper alloy with spring-like qualities which may be introduced by heat-treat processing. A gold or silver plating will prevent oxidation on the contact pin.

The connector also comprises a multi-piece dielectric housing. It preferably is comprise of at least three separate pieces, which are preferably constructed from a glass-filled thermoplastic material. The glass fiber enhances the strength of the material while the thermoplastic material is selected for its dielectric properties. Additional dielectric members used to make the connector, such as gaskets, may be constructed of any suitable compressible material, such as an elastomeric polymer. Gaskets may be positioned between the layers of glass-filled thermoplastic, and may be useful to as a moisture barrier as well as a dielectric material. All dielectric members surrounding the contact pins contain holes for the pins in matching arrays. The holes are preferably configured so that they perfectly match, protect, and mechanically retain the contact pins. Electrical creepage barriers are preferably built in. These barriers may be in the form of tubes that marginally extend beyond the surround the matching holes of the laminating face of the two outer dielectric members. These tubes preferably extend through the matching holes in the elastomeric sealing gasket and into the matching holes on both laminating faces (either side) of a center main dielectric member.

When the connector is fully assembled, all laminating dielectric components surround and captivates all electrical contacts. On the proximal end of the connector the male cylindrical pin extends beyond the flat face of the dielectric member. This extension may be of any suitable length, but is preferably about 1.5 inches. The slotted tubular spring members are contained within, shrouded and protected, by the distal dielectric member. This distal dielectric member also has matched holes that allow male electrical contacts, similar to those described as in the proximal face of the connector, to enter the slotted tubular end of the contact pin. In an aircraft application, the male electrical contacts are the pins on the fixed ground power connector attached to the exterior of the aircraft.

The assembled integrity of the connector is maintained by at least one releasable fastener, such as a screw. Preferably, the connector is held together by four screws. The screw preferably penetrates through all dielectric components extending from the proximal face of the connector and are threaded into metal bushings that are an integral part of the distal dielectric member. Prior to coupling the connector to the male pins to which it is to be connected, the screw or other fastener is loose enough to permit the distal end of the connector to be easily pushed over the male pins. It is in this state that the connector is coupled to the male pins, such as may be found on an aircraft fixed connector. The distal end of the connector is pushed over the pins on the aircraft fixed connector causing the pins to enter the slotted tubes the already-described male/female electrical contacts. Once the dielectric faces of the aircraft fixed connector and the connector of the invention are in close contact, pressure is maintained on the proximal end of the connector while the fastener is tightened. The screws or other fastener pull all dielectric components together, forcing the angular crests on the end of end spring member of the tubular end into a conical section of the holes within the distal dielectric member. The “valve seat” phenomenon of this angular crest conical hole forces a sphincter action through each tubular spring member around each male pin of the aircraft fixed connector. This sphincter tension translates into a large force on the male pins, up to hundreds of pounds, that maintains the integrity of the electrical connector between the connectors.

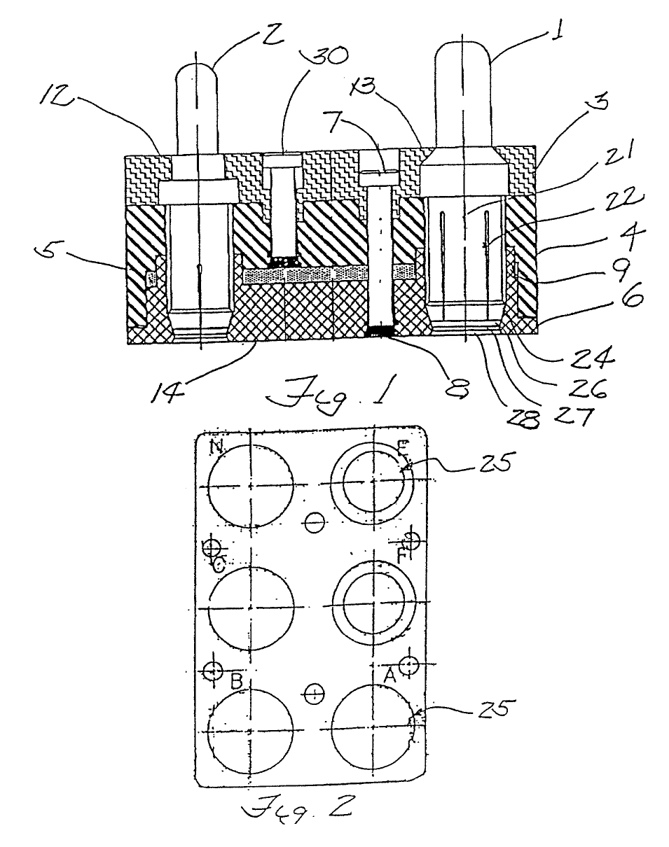

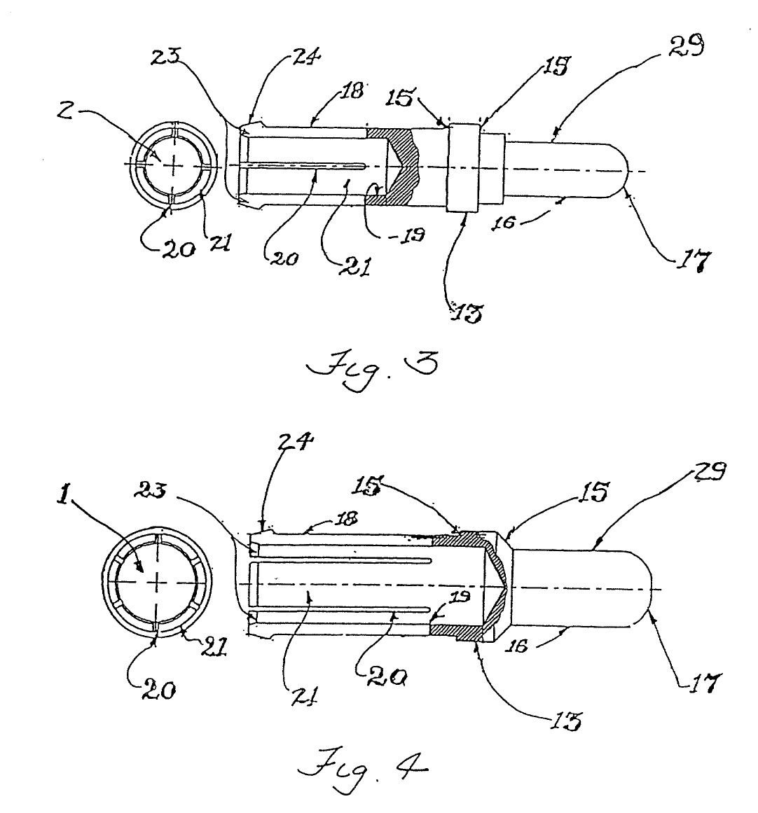

FIG. 1 shows one embodiment of a connector having a male gender face 12 and a female gender face 14 and electrical contact pins 1, 2. The number, arrangement, and size of pins in the connector may be of any suitable configuration. For aircraft ground power supply applications the standard configuration of the aircraft exterior plug is a six-pin arrangement of four power contact pins and two relay contact pins, so the preferred connector of the invention likewise has the same configuration so that is may be connected directly to standard aircraft ground power supply equipment that is widely in use.

The housing of the connector embodiment shown in FIG. 1 is an assembly comprised of a pin retainer block 3, a body retainer block 4, a gasket 5, and a socket retainer block 6, all of which are comprised of any suitable dielectric material and have hollow portions therein of a size to receive and hold the connector pins when the housing components are fastened together. The pin retainer block and the socket retainer block are held together by screws 7, although any suitable fasteners that hold the assembly together sufficient to cause the female end to apply a sphincter force to the male pin inserted therein may be utilized.

Included within and held substantially stationary to screws 7, 30 are metal threaded inserts 8. An electrical creepage barrier 9 is positioned between the body retainer block 4 and the socket retainer block 6. The creepage barrier extends the surface distance between the contact pins 1, 2. The contact pins may be held securely within the connector by means of an annular ring 13. The annular ring 13 is an integral part of the pin and has a bearing surface 15 held perpendicular to the central axis of the pin. These surfaces may be lightly angled as a method of increasing the bearing surface. Each pin has a cylindrically shaped proximal end 16 that extends from the annular ring 13 and terminates as a self-guiding spherical radius 17. This proximal end comprising the cylinder 16 and self-guiding spherical radius 17 constitutes the male portion of contact pin. These cylinders 16 extend beyond the surface 12 of the connector adapter 10. the distal end of the contact pins have are tubular in shape having a hole or bore 19. This bore is of a diameter and depth that readily accepts the full length of the pin contacts on the connector to which is will be attached, such as an aircraft ground power connector. The cylinder 18 has slots 20. There may be several individual beam members 21. The beam members are preferably collapsed towards the internal radial and longitudinal center point 22. These beam members 21 may be sprung open by the entry of an equivalent size cylinder 16, but will retract to the collapsed position upon withdrawal of cylinder 16. At the bore 19 entry is preferably a chamfer 23 for easy entry in the event of a slight misalignment of a similar cylinder 16. On the outside diameter of the tubular end of the contact pins and at the ends of each beam member 21 is a raised crown or wedge 24.

The contact pins are held securely within the connector. The annular ring 13 is layered between the body retainer block 4 and pin retainer block 3 and axial movement is prevented in both a forward and rearward direction. Holes 25 are strategically configured within the socket retainer block 6, gasket 5, body retainer block 4 and pin retainer block 3. These holes 25 closely approximate the outer configuration of the male/female electrical contact pins. These crest or crowns 24 interface and nest within a conical hole 26 that is a portion of hole 26 within the socket retainer block 6. This conical hole 26 decreases in size to a cylindrical hole 27 that accepts a cylinder or pin size equivalent to cylinder 16. A lead in chamfer 28 is configured from the socket retainer block 6 down to the cylindrical hole 27 in the event of a mis-aligned pin on the aircraft fixed connector.

The connector is loosely assembled together with screws 7 passing through holes 25 configured within the pin retainer block 3, body retainer block 4, and gasket laminate 5 and are loosely screwed into permanently affixed metal threaded inserts 8.

The connector may be assembled such that the front face 14 of the socket retainer block 6 is pushed down over the electrical contact pins on the aircraft fixed connector. Once pins on the aircraft fixed connector fully enter the bores 19 within the female ends of the pins, the screws are fully tightened. As screws 7 are tightened, the conical holes 26 within the 26 within the holes 25 of the socket retainer block 6 are forced over the angles of the crest 24 of the individual beams members 21 at the distal end of the contact pins. This action forces a sphincter reaction of the individual beam members 21 around the aircraft fixed connector pins. Subsequently, the ground supply free connector (ground power plug) is coupled onto the male/female contact pins 29. The described sphincter force is greater than the force required to uncouple a ground power plug from the connector 10.

When the pins 29 on the connector or the sockets within the ground power plug are worn due to arcing and/or repeated coupling and uncoupling of the ground power plug the connector is removed by loosening screws 7; then tightening the ejector screws 30.

1. An aircraft ground power connector comprising:
(a) a plurality of electrical contact pins embedded in an insulating housing wherein each pin has a male end and female end and is arranged in the housing so that the male ends are protruding from a male side of the connector, and the female ends of the pins (i) are recessed in a female side of the connector, (ii) have a shape, length, and diameter adapted to permit them to receive a male pin, and (iii) have slots in the sides thereof;
(b) wherein the insulating housing has at least two layers of insulating material arranged perpendicular to the direction of the pins, a first layer of insulating material is positioned on the female side of the connector, the first layer and the portion of the female end of the pins embedded therein are shaped to prevent the pin from being pushed out of the female side of the connector; and a second layer of insulating material is positioned so that at least a portion of the slotted female ends are embedded therein, and the second layer is shaped so that it applies pressure to the outer periphery of at least one female end sufficient to reduce the size of its inner periphery; and
(c) a releasable fastener that holds the first and second layers of the insulating material together.

2. The connector of claim 1 attached to at least one male electrical pin on an aircraft exterior, wherein the female end of the connector pin applies a sphincter force to the male pin on the aircraft exterior.

3. The connector of claim 2 wherein the female side on the connector is attached to a ground power plug, and the sphincter force is greater than the force required to uncouple the plug from the connector.

4. The connector of claim 3 wherein removal is achieved by loosening holding screw/members and tightening ejection screw/members.
